(19) United States
(12) Patent Application Publication
(10) Pub. No.: US 2013/0201099 A1
(43) Pub. Date: Aug. 8, 2013

(54) METHOD AND SYSTEM FOR PROVIDING A MODIFIED DISPLAY IMAGE AUGMENTED FOR VARIOUS VIEWING ANGLES

(71) Applicant: Orto, Inc., Seattle, WA (US)

(72) Inventors: Keith Guerin, Seattle, WA (US); Javier Gonzales Sanchez, Seattle, WA (US); Timothy Hetland, Mercer Island, WA (US)

(73) Assignee: ORTO, INC., Seattle, WA (US)

(21) Appl. No.: 13/754,861

(22) Filed: Jan. 30, 2013

Related U.S. Application Data
(60) Provisional application No. 61/593,976, filed on Feb. 2, 2012.

(51) Int. Cl. G06F 3/00

(52) U.S. Cl. CPC G06F 3/005
USPC 345/156

(57) ABSTRACT

An image augmentation method for providing a modified display image to compensate for an oblique viewing angle by measuring a viewing position of a viewer relative to a display screen; calculating a three-dimensional position of the viewer relative to the display screen; calculating an angular position vector of the viewer relative to the display screen; generating a rotation matrix as a function of the angular position vector; calculating a set of perimeter points; generating a modified image as a function of a normal image and the previously calculated perimeter points; and rendering the modified image on the display screen.

### TECHNICAL FIELD

This invention relates to display images, and in particular to a method and system for augmenting a display image in accordance with the viewing angle of the viewer to provide a modified image that appears to be orthogonal to the viewer regardless of the viewing angle.

### BACKGROUND OF THE INVENTION

The best way to view a display screen is straight on, or, orthogonally. However, due to the fixed positioning of large displays, it's often difficult to view a screen in this wad The result is a poor viewing respective and/or physical discomfort. For example, a large television set cannot be easily rotated to accommodate all seats, especially by the elderly, children, and physically disabled. The result is that viewers are left with poor viewing angles and a sub-optimal viewing experience. In another example, a table-top touch device requires the viewer to look down at his or her hands, causing a distorted trapezoidal picture and neck strain.

As display screens continue to increase in size and ubiquity, these problems will only be exacerbated.

### SUMMARY OF THE INVENTION

The present invention solves these problems by modifying the screen image itself (rather than the physical device), so that it always appears orthogonally orientated towards the viewer. This invention does this by capturing the viewer's focal point and then using that input to create an optical illusion, altering the screen image so as to appear square on. This delivers a better overall viewing experience. The viewer may also be referred to as a user of the system.

For people watching TV in their living rooms, this eliminates the need to physically rotate the television to a proper viewing angle, and ensures that people actually get to view their television's picture the way it was meant to be experienced. For people using large format touch devices (for example PIXELSENSE by MICROSOFT), the present invention removes the trapezoid effect, and reduces the ergonomic issues that result from looking down at your hands.

The methodology of the present invention uses information about a viewer's focal point to continually keep a screen-image orthogonally orientated towards them. The invention operates as a platform-agnostic software algorithm that can be integrated at the application or operating system level, making it easy to plug into any device, including but not limited to television sets, game consoles such as MICROSOFT XBOX and KINECT, APPLE IOS devices, and MICROSOFT WINDOWS devices.

Thus, the present invention provides an image augmentation method for providing a modified display image by measuring a viewing position of a viewer relative to a display screen; calculating a three-dimensional position of the viewer relative to the display screen; calculating an angular position vector of the viewer relative to the display screen; generating a rotation matrix as a function of the angular position vector; calculating a set of perimeter points; generating a modified image as a function of a normal image and the previously calculated perimeter points; and rendering the modified image on the display screen.

Optionally, these steps may be repeated as the viewer moves with respect to the display screen.

Further optionally, a mean viewing position of a plurality of viewers may be calculated relative to the display screen, and the mean viewing position may then be used to calculate the three-dimensional position of the viewers relative to the display screen.

This invention may be embodied in a system that include an image generation device for generating a normal image; a display screen; a position sensing unit for determining a position of a viewer of the display screen; and an image augmentation device operably connected to the position sensing unit, the position sensing unit, and the image generation device. The image augmentation device includes a processor programmed to execute an image augmentation algorithm by receiving from the position sensing device a viewing position of the viewer measured relative to the display screen; calculating a three-dimensional position of the viewer relative to the display screen; calculating an angular position vector of the viewer relative to the display screen; generating a rotation matrix as a function of the angular position vector; calculating a set of perimeter points; rendering a modified image as a function of a normal image received from the image generation device and the previously calculated perimeter points; and transmitting the modified image to the display screen.

The image generation device may for example be a television receiving device, a computer, or a gaming console. The position sensing unit may for example be a motion detection device or a camera.

In further accordance with the invention, an image augmentation device provides a modified display image, and includes input means for (1) receiving a viewing position of a viewer measured relative to a display screen, and (2) receiving a normal image from an image generation device; output means transmitting a modified image to the display screen; and processing means programmed to execute an image augmentation algorithm by: receiving the viewing position of the viewer measured relative to the display screen; calculating a three-dimensional position of the viewer relative to the display screen; calculating an angular position vector of the viewer relative to the display screen; generating a rotation matrix as a function of the angular position vector; calculating a set of perimeter points; rendering a modified image as a function of the normal and the previously calculated perimeter points; and transmitting the modified image to the display screen.

### BRIEF DESCRIPTION OF THE DRAWING

FIG. 1 is a block diagram of the preferred embodiment system of the present invention showing a viewer in three viewing positions;

FIG. 2 is an illustration of the display screens from a static perspective and as seen by the viewer from the viewer's positions of FIG. 1;

FIG. 3 illustrates the observation point, observation line, and point of interest.

FIG. 4 illustrates the front view of a screen with the xy grid.

FIG. 5 illustrates a 3D view of a screen with an xyz grid.

FIG. 6 illustrates an observation point x-angle.

FIG. 7 illustrates a top view of the sensor with respect to the screen during calibration.

FIG. 8 illustrates a front view of the sensor with respect to the screen during calibration.

FIG. 9 illustrates the viewer position with respect to the screen and sensor during calibration.

FIG. 10 illustrates the tracking angle during calibration.

FIG. 11 is a flowchart of the methodology of the preferred embodiment of the present invention.

FIG. 12 is an illustration of a viewer viewing a large display screen at an oblique viewpoint, with an unmodified prior art image.

FIG. 13 is an illustration of the viewer viewing the large display screen of FIG. 12, with a modified image in accordance with the preferred embodiment of the present invention.

FIG. 14 is an illustration of a surface computer viewed at an oblique viewpoint, with an unmodified prior art image.

FIG. 15 is an illustration of the surface computer of FIG. 14, with a modified image in accordance with the preferred embodiment of the present invention.

### DESCRIPTION OF THE PREFERRED EMBODIMENTS

Viewer Experiences

Various viewer experiences are addressed by the present invention, as described herein.

Television (or Other Large-Format Display Screens Such as a Theater)

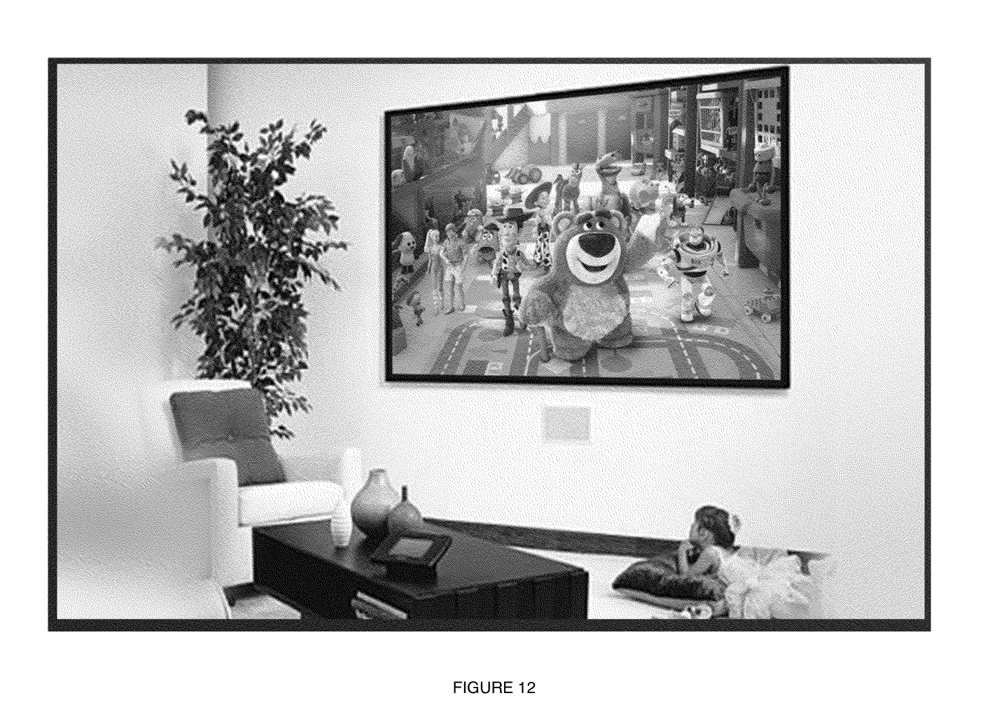

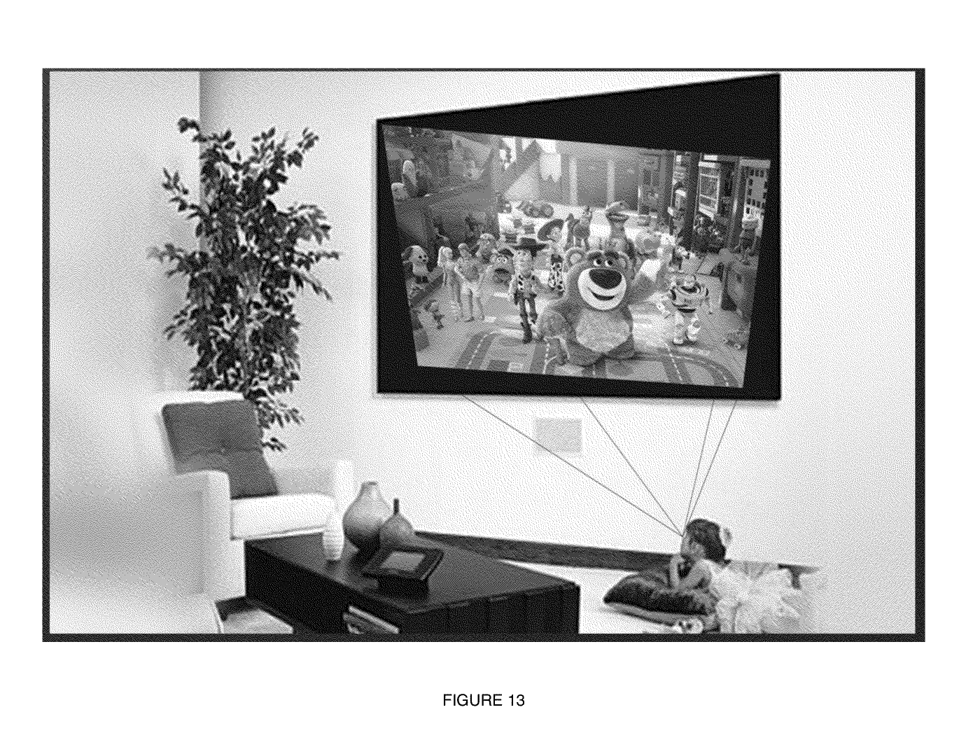

In a first case, a single viewer is sitting in a still position, as shown in FIG. 12. That is, the viewer sits in their living room to watch television. Their seat is not directly square with the television, so the picture is distorted. They activate the present invention (for example by using a voice command, or by pressing a certain button on their remote/interface). The invention uses a motion capture device or camera to detect the viewer's location, and displays a picture that has been optimized for that viewpoint as shown in FIG. 13.

In a second case, a single viewer is not still but is moving around the viewing environment. Here, the viewer turns on the television to watch while they do another activity (e.g. cleaning, cooking). They activate the invention, and it continually tracks their location, adjusting it to always be optimized for their latest viewpoint. The picture always appears rectangular, or as close to rectangular as possible based on the detected knowledge of their location. For example, if they exit the viewing area to the right, it will stay optimized for that viewpoint until they re-enter the viewing area.

In a third case, there are multiple viewers; for example a group of two or more people watching television together. The system determines where each viewer's focal point is, and then determines a mean focal point to optimize the view for the group. For example, if most viewers of the group are off to the left, then the display screen shows a picture optimized for that area.

In a fourth case, there are multiple viewers with an advanced multi-image display. Advances in display technology have allowed for multiple images to be viewed on the same screen. These are now available on the consumer market and rapidly becoming sophisticated and affordable. When this feature is available, each viewer is tracked and provided with their unique optimized view. When using a multi-image display at once, each viewer is tracked and provided with their unique optimized view.

Multi-Touch Computing

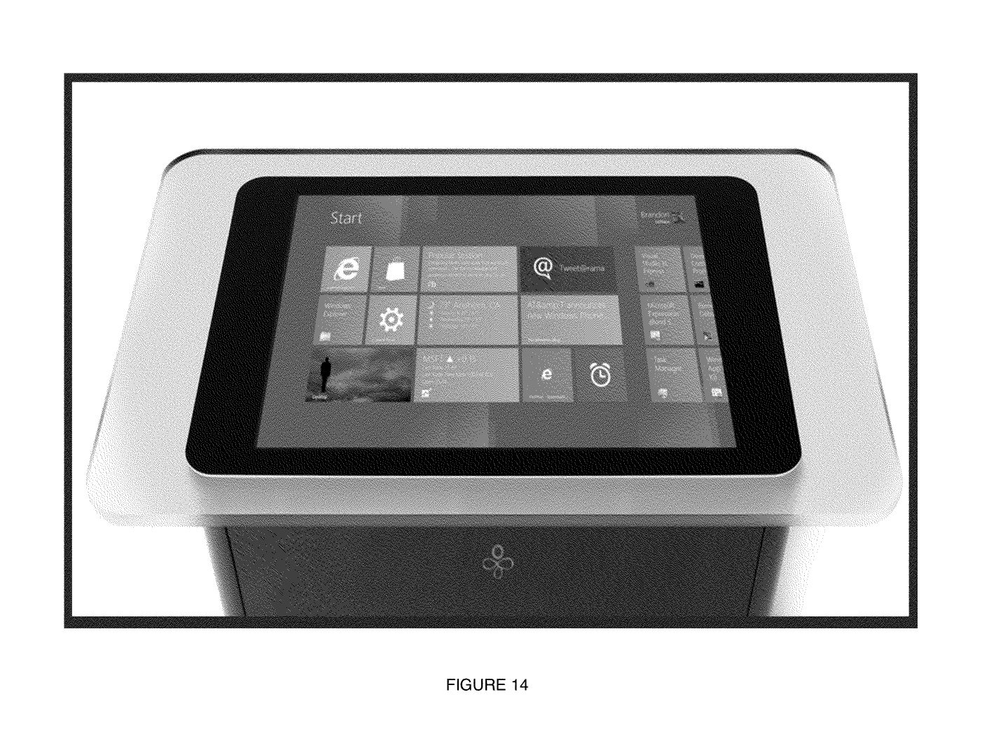

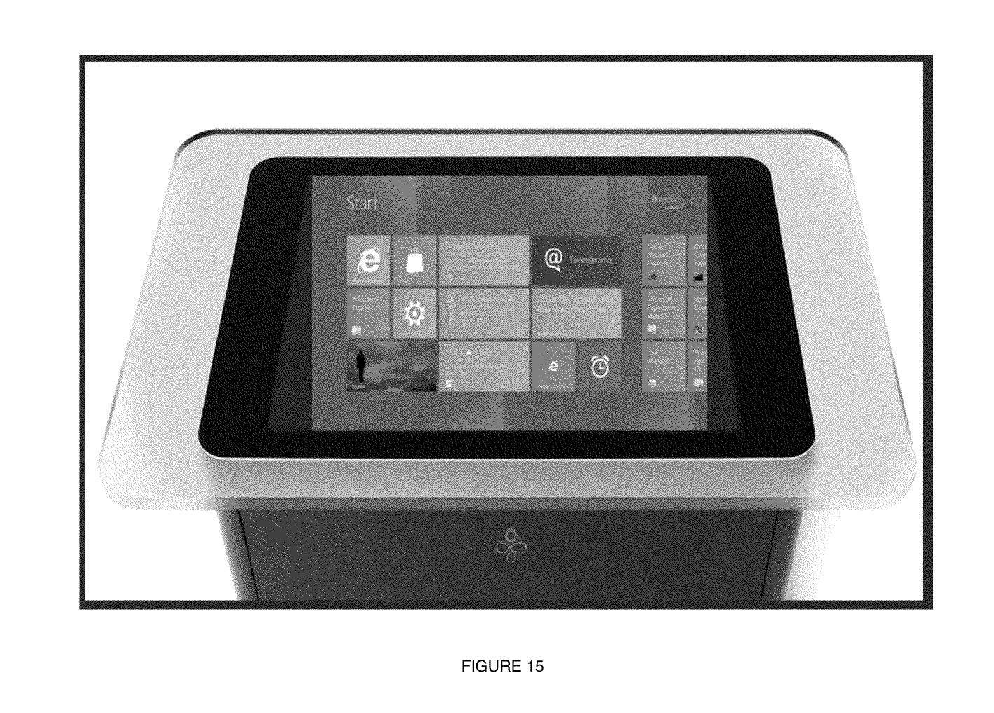

In this case, the display is located flat on a table-top as shown in FIG. 14, or on a slight angle like a drafting table. Because the viewer's focal point is to the side of the table, rather than directly above it, the picture is distorted. The system detects the viewer's focal point, and modifies the image to be undistorted from their perspective as shown in FIG. 15.

Gaming

In this case, a viewer is playing a game such as by using the MICROSOFT KINECT console, and so they are moving around the stage. Instead of the full picture, just a single or few elements are controlled by the present invention. For example, a heads-up display (HUD) may be utilized, which displays information in the corners of the screen in most games. As the viewer moves, the system tracks the viewer and adjusts these items to be oriented to their viewpoint. In this scenario, the effect is not to provide a rectangular picture, but to enhance the sense of immersion and realism. As the viewer moves left/right/up/down, the elements subtly respond providing a sense of depth and realism, as well as fixation to their viewpoint.

Basic Description of the Preferred Embodiment

Setup

The system must first be configured with information about the display device and the viewing environment. An on-boarding wizard walks the viewer through this process, and does calculations in the background.
1. If the position of the motion-tracking device is unknown, it asks for information about its location—the X, Y, and Z distance from the center of the display. The center of the display is (0, 0, 0).
2. If the size and specifications of the display are unknown, it asks for this information: size in inches, and resolution.
3. It uses the motion-capture device to measure the position of the body in relationship to the motion-capture device and display. The position and movement are used to refine and verify the calibrations.

In-Use

The system uses the motion-tracking device to determine the viewer's focal point, and applies the augmentation algorithm to any onscreen elements (or the full display screen) to provide a modified image. The system may perform this calculation and transformation as little as once-per-session, or as frequently as every frame of video (24+ fps). For each viewer on the stage:
1. Use SDKs for skeletal-tracking or facial-detection, in addition to other methods to determine the current position of the viewer's face, and thus their focal point, in relationship to the center of the display
2. Use the viewer's position to create a rotation matrix.
3. Apply the rotation matrix to the original picture. This creates a modified image.
4. Display the modified image on screen to the viewer, and then repeat the process. If the viewer has a auto-enlarge setting enabled, the modified image is scaled to fill the screen as much as possible.

The preferred embodiment will now be described in further detail with respect to the Figures, and using the following defined terms:

Angular Position Vector—A vector from the center point to the observation point. The Observation Point X-Angle can be derived from the angular position vector by: 1) adding together the angular position vector's x and z component vectors; and 2) calculating the angle between the z-axis and the vector created in the previous step. The Observation Point Y-Angle can be derived from the angular position vector by calculating the angle between the angular position vector and the xz plane (the plane where y=0).

Center Point—The 3D coordinate (0, 0, 0) in the common coordinate system. The center of the display is always the center point.

Common Coordinate System—A 3D coordinate system that contains all the elements mentioned in the calibration and visual augmentation algorithms. The common coordinate system is anchored to the display with the center of the displaying always being the 3D coordinate (0, 0, 0), a.k.a center point.

Base Graphic—any type of shape, image, or video that can be displayed on a screen. A base graphic is the reference for producing an optical illusion. The base graphic has one or more points and those points exist on the display screen (the XY plane in the common coordinate system where z=0).

Focal Point—A viewer has one focal point in each eye, where light is received. When referring to the viewer's Focal Point, we are typically referring to a single point at the mean location of these two focal points (approx. 1″ behind the nasal bridge).

Projected Point—The point where an observation line intersects the screen; mathematically this requires finding the point on the observation line where z=0.

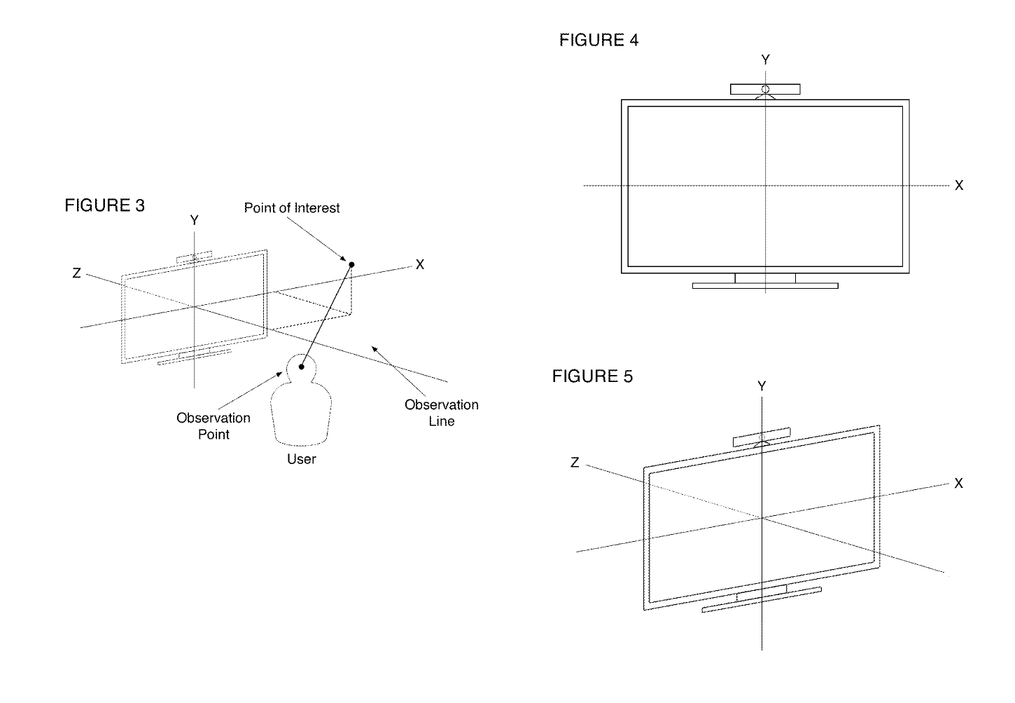

Observation Line—A line that contains a 3D point of interest and the observation point. Every point can have an observation line. See FIG. 3.

Modified Image—An optical illusion that is derived from a base graphic. The base graphic is augmented, stretched, and/or skewed on screen such that an observer viewing the augmented image from a prescribed angle will perceive the original base graphic, as if the observer was viewing the original base graphic while standing directly in front of the screen. Typically the modified image is regenerated as the observer moves their observation point about the common coordinate system.

Motion-capture device—A computer input device that gathers information from the viewer's physical environment, such as visible light, infrared/ultraviolet light, ultrasound, etc. For example: A KINECT sensor, or a simple camera. These devices are rapidly becoming more sophisticated and less expensive. The device sometimes comes with software that helps the present invention determine the location of the viewer, using skeletal tracking or facial detection.

Tracking Angle—The maximum angle from the center of the sensor where the sensor is able to track an object. A sensor can have multiple tracking angles that are different (e.g. horizontal and vertical).

Screen—Any visual display device that displays two dimensional images on a flat service. The screen represents a geometric plane (with an x and y axis). The x-axis runs horizontally across the screen through the screen's center point; if looking at the front of the screen, positive values of x are to the right of the center point and negative values of x are to the left of the center point. The y-axis exists vertically across the screen and contains the screen's center point; if looking at the front of the screen, positive values of y are above the screen's center point and negative values of y are below the screen's center point. The x-axis and y-axis are perpendicular; a vector existing on the x-axis is orthogonal to a vector existing on the y-axis. See FIG. 4.

For the purpose of calculations, the screen also has a z-axis that contains the screen's center point and is orthogonal to the xy-plane. Positive values of z are in front of the screen (where the use/observer is expected to be). Negative values of z are behind the screen. The screen physically exists on the xy-plane (where z=0). See FIG. 5.

Observation Point—A 3D point in the common coordinate system that represents the location of an observer's point of reference; ideally this would be the location of the area between the observer's eyes, but could be the general location of the observer's head.

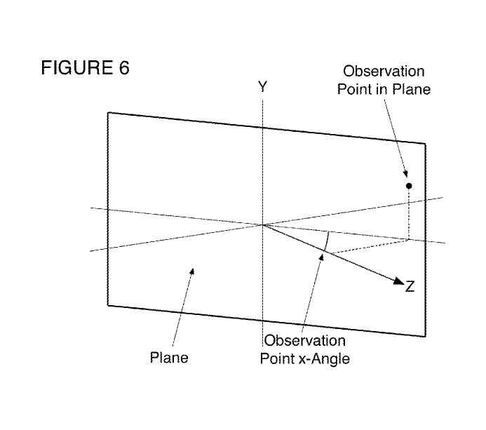

Observation Point x-Angle—the angle between: 1) the z-axis; and 2) a plane that contains both the observation point and the y-axis. See FIG. 6.

Observation Point y-Angle—the angle between the angular position vector and the xz plane (the plane where y=0).

Sensor—The sensor tracks objects of interest, providing the visual augmentation algorithm with information needed to determine the Observation Point x-Angle and the Observation Point y-Angle.

Rotation Matrix—matrix R is a standard matrix for rotating points in 3D space about an axis.

$$R = [ \begin{matrix}{tx}^{2} + c & txy - sz & txz + sy \\ txy + sz & {ty}^{2} + c & tyz - sx \\ txz - sy & tyz + sx & {tz}^{2} + c\end{matrix} ]$$

Where: c=cos θ s=sin θ t=1−cos θ

And (x,y,z) is a unit vector on the axis of rotation. To rotate a point P at coordinates (Px,Py,Pz) about the axis containing unit vector (x,y,z) by the angle θ perform the following matrix multiplication:

$$R \cdot [ \begin{matrix}{P}_{x} \\ {P}_{y} \\ {P}_{z}\end{matrix} ] = [ \begin{matrix}{N}_{x} \\ {N}_{y} \\ {N}_{z}\end{matrix} ]$$

Where the coordinates of the point P after the rotation are Nₓ,N_{y},N_{z}

It is noted that that this matrix is presented in Graphics Gems (Glassner, Academic Press, 1990).

Stage—The physical area that is monitored by a motion-capture device, such as a room.

Tracking Matrix—a data structure that, once initialized, contains all the coordinate information necessary to generate a modified image from a base graphic. The tracking matrix is a collection of coordinate points organized into three sets per row. The three sets are Base Graphic Points, Virtual Points, and Projected Points.

An example of an initialized Tracking Matrix:

| | Base Graphic Points | | | Virtual Points | | | Projected Points | | |
|---|---|---|---|---|---|---|---|---|---|
| | X | Y | Z | X | Y | Z | X | Y | Z |
| Relative | 0 | 1 | 0 | N/A | N/A | N/A | N/A | N/A | N/A |
| Y-axis | | | | | | | | | |
| Relative | 1 | 0 | 0 | | | | N/A | N/A | N/A |
| X-axis | | | | | | | | | |
| Point 1 | 438 | −23 | 54 | | | | | | |
| Point 2 | 23 | 65 | 34 | | | | | | |
| Point 3 | −54 | 432 | 23 | | | | | | |
| Point 4 | 234 | −45 | 67 | | | | | | |

Coordinates in the Base Graphic Points set are 3D points that describe the base graphic (the original graphic used to generate a modified image). Coordinates in the Virtual Points set represent base graphic points that have been rotated once or twice in the common coordinate system. Coordinates in the Projected Points set represent the actual points used to draw the modified image on the screen (technically they are the projected point for the virtual point's observation line).

The tracking matrix consists of a Relative Y-Axis row, Relative X-Axis row, and one or more Point rows. The Relative Y-Axis represents the modified image's relative y-axis. The relative y-axis is used only for the first rotation. A virtual point and a projected point are never calculated from the Relative Y-Axis's Base Graphic Point.

The Relative X-Axis represents the modified image's relative x-axis. The Relative X-Axis's Base Graphic Point is rotated during the first rotation, producing the coordinates for the Relative X-Axis's Virtual Point. This virtual point is then used as the unit vector for the second rotation. The Relative X-Axis's Virtual Point are not rotated and subsequently updated as part of the second rotation.

For each Point in the tracking matrix the Base Graphic Point is a point in the actual base graphic. The coordinate in the Base Graphic Points set is rotated about the relative Y-Axis to produce the coordinates for the virtual point. Those coordinates are entered into the virtual points coordinates set on the same row. The Virtual Point coordinates are rotated about the Relative X-Axis, producing new coordinate values that overwrite the previous Virtual Point coordinate values.

For each Point row, the coordinate in the Projected Points set is derived from the coordinate in the Virtual Points set by calculating the projected point for the virtual point's observation line.

Tracking Matrix Phases—There are four phases of a Tracking Matrix.

1. Phase-1: Initialized—The coordinates in the Base

Graphic Points set are initialized.
a. The Relative Y-Axis coordinate is initialized to (0, 1, 0)
b. The Relative X-Axis coordinate is initialized to (1, 0, 0)
c. For each point in the base graphic, the point's coordinate is entered in a dedicated row of the tracking matrix as the row's Base Graphic Point coordinate.

2. Phase-2: Rotation About Relative Y-Axis—The Base Graphic Points are rotated about the unit vector defined in the Relative Y-Axis Base Graphic coordinate and are rotated by the value Observation Point X-Angle.
a. Rotate the Relative X-Axis Base Graphic Point coordinate about the unit vector defined in the Relative Y-Axis Base Graphic Point coordinate and by the value Observation Point X-Angle. Store the newly generated coordinate as the X-Axis Virtual Point coordinate value.
b. For each Point, rotate the Point's Base Graphic Point coordinate about the unit vector defined in the Relative Y-Axis Base Graphic Point coordinate and by the value Observation Point X-Angle. Store the newly generated coordinate as the Point's Virtual Point coordinate value.

3. Phase-3: Rotation About Relative X-Axis—The Virtual Points are rotated about the Unit vector defined in the Relative X-Axis Virtual Point coordinate and are rotated by the value Observation Point Y-Angle.
a. The value of the Relative X-Axis Virtual Point coordinate is not modified.
b. For each Point, rotate the Point's Virtual Point coordinate about the unit vector defined in the Relative X-Axis Virtual Point coordinate and by the value Observation Point Y-Angle. Overwrite the existing Point's Virtual Point coordinate with the newly generated coordinate.

4. Phase-4: Projected Points Generated
a. For each Point, calculate the projected point for the virtual point's observation line. Store the coordinates for the projected point in the Point's Projected Point coordinate.

System Description

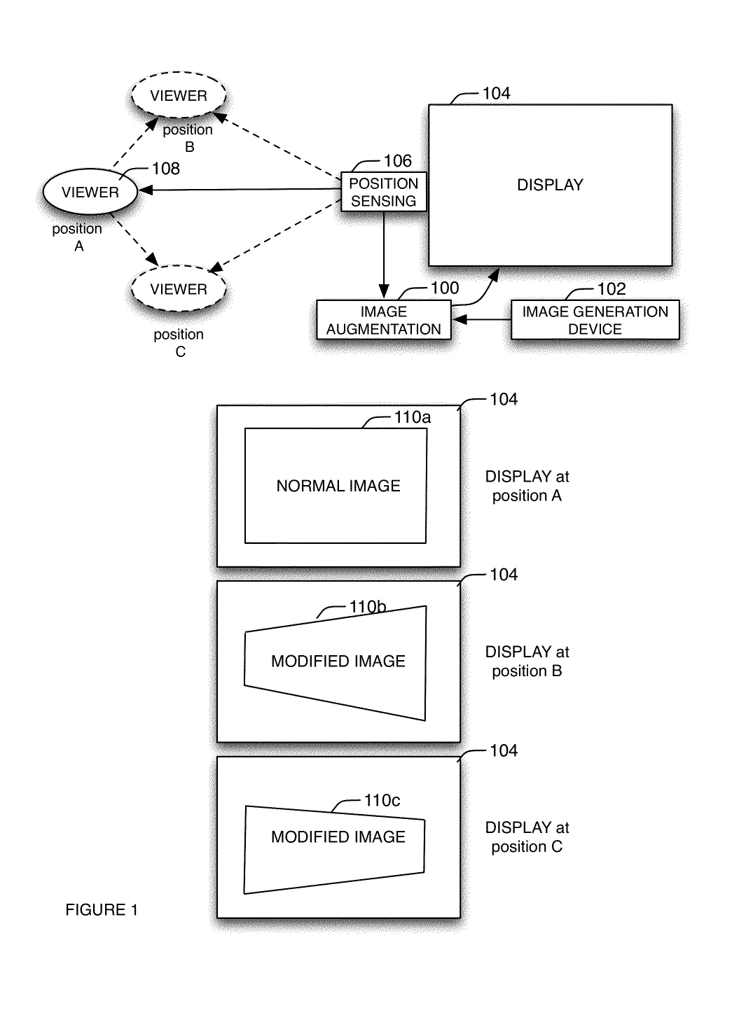

The overall system for implementing the present invention is shown in FIG. 1, which also shows a viewer in three viewing positions. The system includes as its basic components an image augmentation device 100, an image generation device 102, a position sensing device 106, and a display device 104. The image generation device may be a known prior art devices that outputs a display image such as a television receiver (satellite, cable, etc.), a DVD or BLURAY device, a gaming console such as an XBOX or WII, a computer, etc. The position sensing device 106 may be any known device for observing and/or detecting the position of a viewer 108 in the viewing area. For example, the position sensing device 106 may be a digital camera, a camcorder, a motion tracking device such as a MICROSOFT KINECT, etc. The display device may be any type of display unit such as a television or monitor (e.g. plasma, flat screen, LCD, LED, etc.).

Normally, the image generation device will send normal display images directly to the display 104. The present invention system adds the image augmentation device 100, which may be a general or special purpose computer programmed as described herein to incorporate the image augmentation methodologies of the present invention. In an alternative embodiment, the image augmentation device 100 and/or its programming may be incorporated directly into the image generation device 102, the display 104, and/or the position sensing device 106, as may be desired.

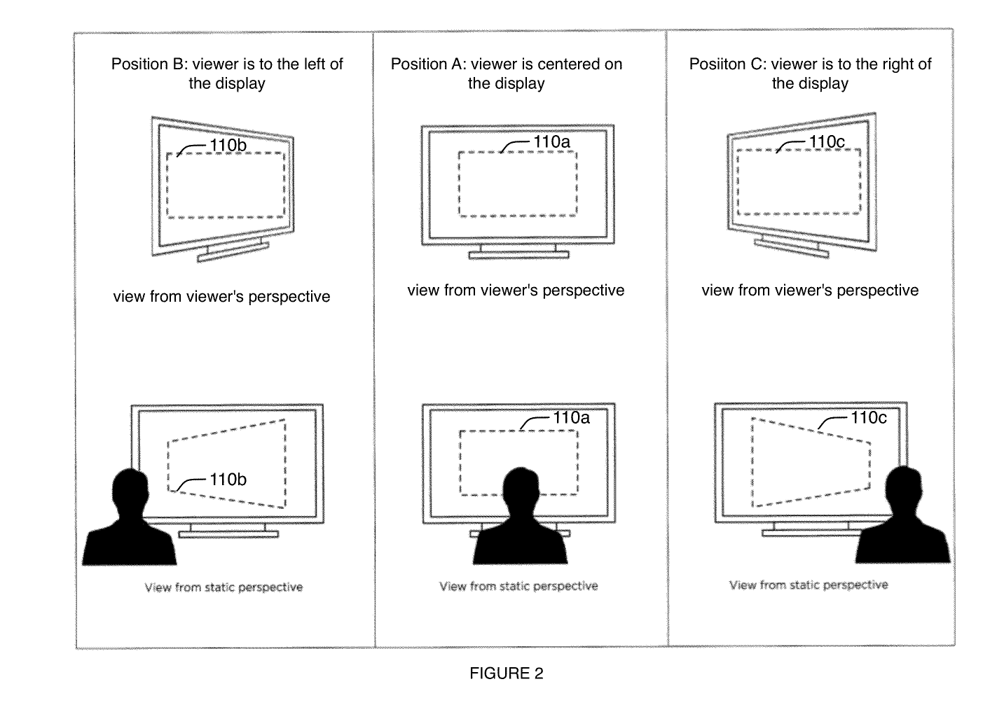

Also shown in FIG. 1 is a rendering of a normal image 110a on the display 104, when the viewer is detected to be at position A, which is orthogonal to the display 104. When the viewer is detected to be at position B (to the left of the display), then a modified image 110b is rendered and displayed as shown (this is how the image would appear when looking directly into the display 104). Similarly, when the viewer is detected to be at position C (to the right of the display), then a modified image 110c is rendered and displayed as shown (this is how the image would appear when looking directly into the display 104). FIG. 2 illustrates these same perspectives at the bottom row, but what the viewer will actually see is shown in the top row. Thus, the modified image as generated by the augmentation methodology of the present invention compensates for oblique viewing angles so the viewer still sees what appears to be an orthogonal (normal) image.

Calibration

For the calibration algorithm, the sensor tracks the location of a tracked object using a combination of distance from the sensor and the location of an object on a display screen. This is different from tracking an object using a pure 3D coordinate system.

After the calibration is performed good estimates will be established for the sensor's max horizontal viewing angle, the sensor's max vertical viewing angle, and the ratio to convert the sensor's unit of distance into a common unit of measurement used by the display (e.g. pixels). This information is needed to calculate the Observation Point X-Angle, Observation Point Y-Angle, and length of the angular position vector.

Procedure
1. The viewer confirms that the sensor is vertically aligned with the center of the display screen.
   a. The sensor may be aligned below or above the display.
   b. The sensor should be as close as possible to the center of the display.
   c. The sensor should roughly be in the same plane as the display.

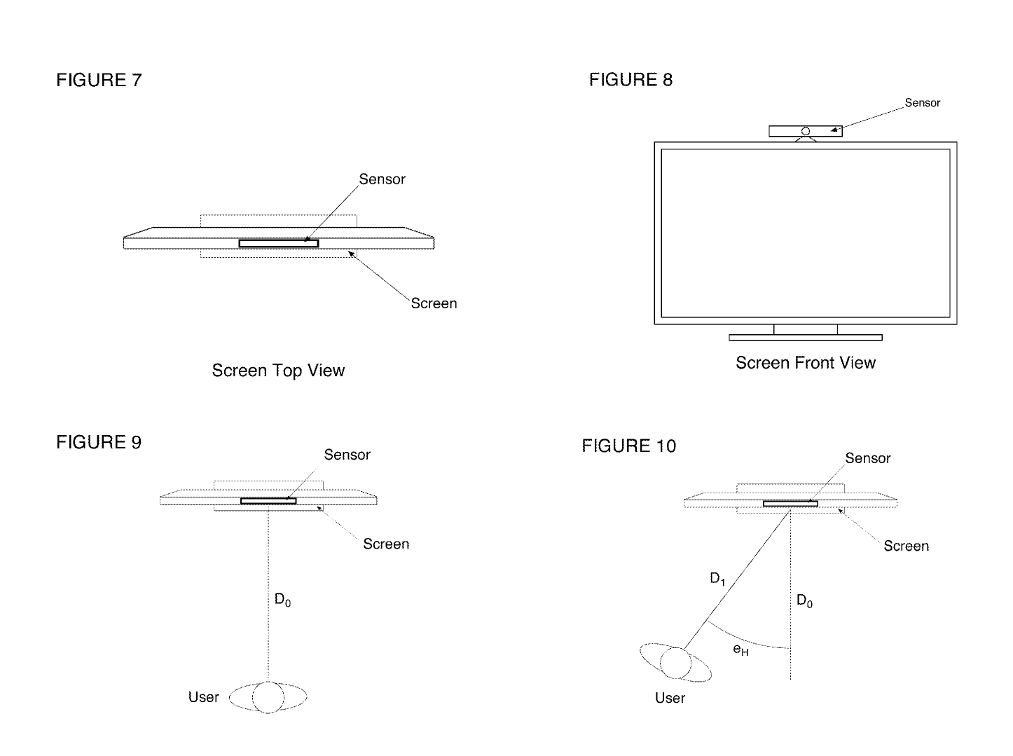

See FIGS. 7 and 8.
2. The viewer is instructed to stand in front of the sensor, aligning their face with the center of the display. The viewer knows he has accomplished this when the viewer's face is roughly centered on the display.

The sensor calculates the distance D₀ to the viewer in the sensor's unit of measurement for distance.
3. The viewer is instructed to move to either the left or right in a motion that is parallel to the surface of the display.
4. The viewer is asked to stop once the sensor is no longer able to track the viewer, due to the viewer moving beyond the sensor's range of detection. Calculate the viewer's current distance D₁.
5. Calculate the horizontal tracking angle as:

$${θ}_{H} = {cos}^{- 1} ( \frac{{D}_{0}}{{D}_{1}} )$$

6. Calculate the vertical tracking angle as:

$${θ}_{V} = {θ}_{B} ( \frac{Sensor Screen Height}{Sensor Screen Width} )$$

where: Sensor Width and Height are the dimensions of the sensor's screen tracking grid.
7. The viewer is asked to not move from their current position.
8. The viewer is presented on the screen with an image of a square that is generated using the Visual Augmentation Algorithm. The distance to the viewer is currently known in the sensor's unit of distance. The viewer is presented with an interface to adjust the ratio of the sensor's unit of distance to the unit of measurement used to paint graphics on the display (e.g. pixels).
9. The viewer adjusts the ratio (up or down) until they see (from their perspective) a perfect square.
10. The viewer confirms and saves the value of the ratio.
11. The Sensor's horizontal tracking angle is now calibrated to θ_{H}, the sensor's vertical tracking angle is now calibrated to θ_{V}, and the ratio to convert the sensor's unit of measurement into a common unit of measurement (e.g. pixels, inches, etc.) is known.

Visual Augmentation Calculations

All rotations are performed by multiplying the rotation matrix R in the manor described in the Rotation Matrix definition.
1. Using sensor data from a calibrated sensor, determine the length of the angular position vector, observation point x-angle, and observation point y-angle.
2. Generate a Phase-1 Tracking Matrix from the actual base graphic.
   a. Initialize the value of the Relative Y-Axis Base Graphic coordinate to (x=0,y=1,z=0)
   b. Initialize the value of the Relative X-Axis Base Graphic coordinate to (x=1,y=0,z=0)
   c. For each point in the actual base graphic:
      i. Create a Point row in the tracking matrix
      ii. Initialize the value of the new Point row's Base Graphic coordinate to the value of the actual base graphic point's coordinate.
3. Generate a Phase-2 Tracking Matrix
   a. Rotate the Relative X-Axis Base Graphic coordinate about the unit vector defined by the Relative Y-Axis Base Graphic coordinate and rotate by the value Observation Point X-Angle. Store the new coordinate value as the Relative X-Axis Virtual Point coordinate.
   b. For each Point, Rotate the Point's Base Graphic coordinate about the unit vector defined by the Relative Y-Axis Base Graphic coordinate and rotated by the value Observation Point X-Angle. Store the new coordinate value as the Point's Virtual Point coordinate.
4. Generate a Phase-3 Tracking Matrix
   a. For each Point, Rotate the Point's Virtual Point coordinate about the unit vector defined by the Relative X-Axis Virtual Point coordinate and rotate by the value Observation Point Y-Angle. Overwrite the existing Virtual Point coordinate with the newly generated coordinate.
5. Generate a Phase-4 Tracking Matrix
   a. For each point in the Tracking Matrix
      i. Determine the observation line for the point's virtual coordinate.
      ii. Calculate the coordinate for the observation line's projected point
      iii. Update the point's projected coordinate value in the tracking matrix with the projected point coordinate calculated in the previous sub-step.
6. Use the projected point coordinates in the Phase-4 Tracking Matrix to render the modified image to the screen.

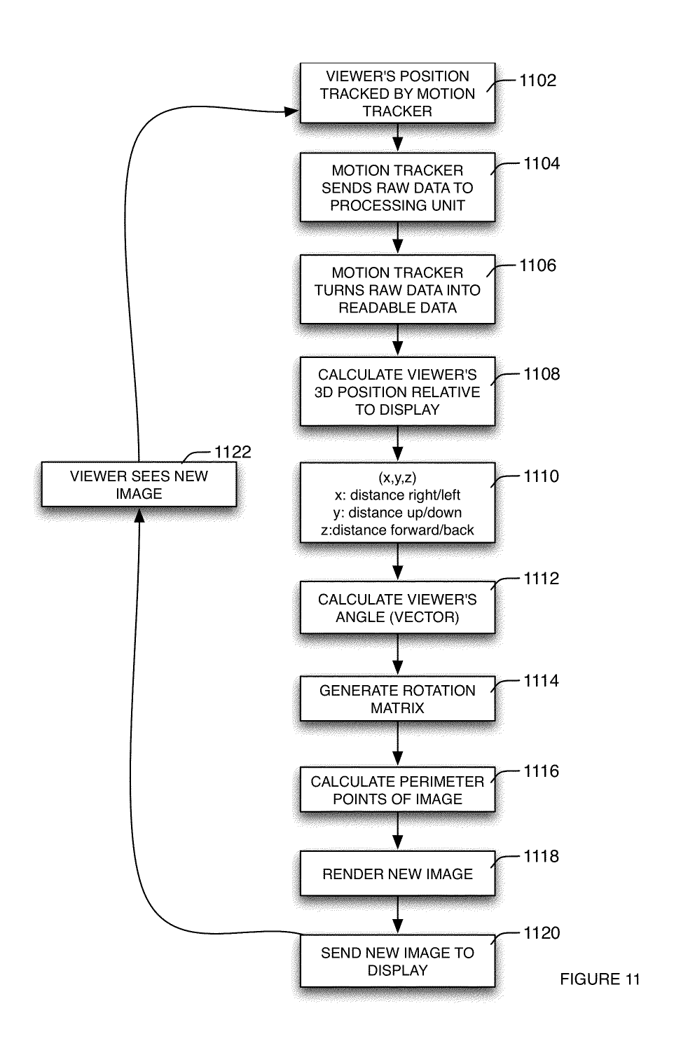

The flowchart of FIG. 11 provides as follows. At step 1102, the viewer's position is tracked by the motion tracker (the position sensing unit 106). This sends the raw data to the processing unit of the image augmentation device 100 at step 1104. At step 1106, the motion tracker turns raw data into readable data, and at step 1108 the viewer's 3D position relative to the display is calculated. As shown in step 1110, these are the x (right/left), y (up/down) and z (forward/back) values. At step 1112 the viewer's angular position vector is calculated, and at step 1114 the rotation matrix is generated. At step 1116 the perimeter points of the image are calculated, and at step 1118 the modified (new) image is rendered. At step 1120 the new image is sent to the display and the viewer sees the modified image at step 1122. This process is the repeated as shown.

What is claimed is:

1. An image augmentation method for providing a modified display image comprising:
measuring a viewing position of a viewer relative to a display screen;
calculating a three-dimensional position of the viewer relative to the display screen;
calculating an angular position vector of the viewer relative to the display screen;
generating a rotation matrix as a function of the angular position vector;
calculating a set of perimeter points;
generating a modified image as a function of a normal image and the previously calculated perimeter points; and
rendering the modified image on the display screen.

2. The method of claim 1 further comprising repeating the steps as the viewer moves with respect to the display screen.

3. The method of claim 1 further comprising calculating a mean viewing position of a plurality of viewers relative to the display screen and using the mean viewing position to calculate the three-dimensional position of the viewer relative to the display screen.

4. A system comprising:
an image generation device for generating a normal image;
a display screen;
a position sensing unit for determining a position of a viewer of the display screen; and
an image augmentation device operably connected to the position sensing unit, the position sensing unit, and the image generation device, the image augmentation device comprising a processor programmed to execute an image augmentation algorithm by:
receiving from the position sensing device a viewing position of the viewer measured relative to the display screen;
calculating a three-dimensional position of the viewer relative to the display screen;
calculating an angular position vector of the viewer relative to the display screen;
generating a rotation matrix as a function of the angular position vector;
calculating a set of perimeter points;
rendering a modified image as a function of a normal image and the previously calculated perimeter points; and
transmitting the modified image to the display screen.

5. The system of claim 4 wherein the image generation device comprises a television receiving device.

6. The system of claim 4 wherein the image generation device comprises a computer.

7. The system of claim 4 wherein the image generation device comprises a gaming console.

8. The system of claim 4 wherein the position sensing unit comprises a motion detection device.

9. The system of claim 4 wherein the position sensing unit comprises a camera.

10. An image augmentation device for providing a modified display image comprising:
input means for (1) receiving a viewing position of a viewer measured relative to a display screen, and (2) receiving a normal image from an image generation device;
output means transmitting a modified image to the display screen; and
processing means programmed to execute an image augmentation algorithm by:
receiving the viewing position of the viewer measured relative to the display screen;
calculating a three-dimensional position of the viewer relative to the display screen;
calculating an angular position vector of the viewer relative to the display screen;
generating a rotation matrix as a function of the angular position vector;
calculating a set of perimeter points;
rendering a modified image as a function of the normal image and the previously calculated perimeter points; and
transmitting the modified image to the display screen.
